(19) United States
(12) Patent Application Publication
(10) Pub. No.: US 2021/0027400 A1
(43) Pub. Date: Jan. 28, 2021

(54) APPARATUS AND METHOD FOR DISPENSING PRE-ORDERED CUSTOM-PREPARED FOOD

(71) Applicant: FOMBOX LLC, Sunny Isles Beach, FL (US)

(72) Inventor: Jorge Carlos Escobar, Sunny Isles Beach, FL (US)

(21) Appl. No.: 16/520,655

(22) Filed: Jul. 24, 2019

(51) Int. Cl. G06Q 50/12; G06Q 20/18; G06Q 30/06

(52) U.S. Cl. CPC G06Q 50/12; G06Q 30/0633; G06Q 20/18

(57) ABSTRACT

Automated vending system for pre-ordered custom-prepared food packages comprises a kiosk for housing a plurality of custom-prepared food packages, each custom-prepared food package associated with a specific order received from a customer, the plurality of custom-prepared food packages positioned in a storage rack within the kiosk. If further includes a robotic arm located within the kiosk, the robotic arm configured to engage a first food package from the storage rack and deliver the first food package to a product delivery area of the kiosk. It also includes a user interface configured for receiving a user selection of the first food package, and a controller configured to command the robotic arm to select and deliver the first food package to the product delivery area.

### TECHNICAL FIELD

The present invention relates to a system and related devices for automated food dispensing; in particular, the invention relates to dispensing of pre-ordered custom-prepared food packages.

### BACKGROUND

There is an increased interest among consumers in consuming healthier foods such as freshly prepared ready-to-eat organic foods. A significant problem with customized and freshly cooked food is the difficulty in economically delivering the freshly prepared ready-to-eat food package to the work location of a customer, for example. A variety of approaches have been tried in an attempt to solve this problem. While the use of a delivery person to deliver food prepared at a restaurant to a customer's location is common, this presents at least two major issues—the delay between the time when food is ordered and the time the food gets delivered, as well as the cost of labor and materials associated with transporting a single order of custom prepared food from the restaurant to the customer's location. A further problem in certain very dense metropolitan areas such as Manhattan, for example, is that food delivery to a customer location can take even more time and cost even more in resources.

There is thus a need for improved methods of delivering custom prepared food in a cost effective and efficient manner.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclose herein is an automated vending system for pre-ordered custom-prepared food packages. The system comprises a kiosk for housing a plurality of custom-prepared food packages, each custom-prepared food package associated with a specific order received from a customer, the plurality of custom-prepared food packages positioned in a storage rack within the kiosk. In one embodiment, the storage rack is a mobile storage rack provided with wheels for mobility. The system further comprises a robotic arm located within the kiosk, the robotic arm configured to engage a first food package from the storage rack and deliver the first food package to a product delivery area of the kiosk. The system also comprises a user interface configured for receiving a user selection of the first food package, and a controller configured to command the robotic arm to select and deliver the first food package to the product delivery area.

According to one or more embodiments, a payment associated with the first food package is received prior to the first food package being loaded to the storage rack.

According to one or more embodiments, an order for the first food package is received prior to the first food package being loaded to the storage rack.

According to one or more embodiments, the robotic arm includes one or more of a QR code reader, a RFID reader, a scanner, and an imaging device configured for interacting with an identifier on the first food package.

According to one or more embodiments, the robotic arm is configured for travelling back and forth along a channel extending within the kiosk.

According to one or more embodiments, the storage rack is rolled into the kiosk.

According to one or more embodiments, the kiosk further comprises one or more of: a refrigeration device for cooling the first food package, and a microwave heating device for heating or reheating the first food package.

According to one or more embodiments, the first food package includes an organic food item.

According to one or more embodiments, the plurality of custom-prepared food packages is loaded onto the storage rack from an opening at or near a top surface of the kiosk.

According to one or more embodiments, the plurality of custom-prepared food packages is loaded onto the storage rack by the robotic arm.

Disclosed herein is a server comprising a processor communicably coupled to at least one memory, and program instructions which when executed by the processor cause the processor to: receive, from a computing device, an order for a first food package to be custom prepared; transmit, to a food preparation facility, the order for the first food package to be custom prepared; track placement and position of the custom-prepared first food package in a storage rack within a vending kiosk, the kiosk configured for housing a plurality of custom-prepared food packages, each custom-prepared food package associated with a specific order received from a customer, the plurality of custom-prepared food packages positioned in the storage rack; receive, on a user interface, a selection of the first food package by a user; direct a controller in communication with a robotic arm located within the kiosk to cause the robotic arm to engage the first food package at the storage rack and deliver the first food package to a product delivery area of the kiosk; and verify completion for the order.

According to one or more embodiments, the server is configured to communicate with a vendor system to coordinate preparation of the custom-prepared first food package at a food processing facility and delivery of the prepared custom-prepared first food package to the vending kiosk.

According to one or more embodiments, the server is configured to communicate with a mobile application operating on a mobile device associated with the customer.

According to one or more embodiments, engaging the first food package at the storage rack includes reading an identifier on the first food package, and wherein directing the controller includes a lookup of a stocking location associated with the identifier of the first food package and communication of the stocking location to the robotic arm.

According to one or more embodiments, the server is further configured to process a payment associated with the order.

According to one or more embodiments, the controller is further configured to track stocking locations of each of the plurality of custom-prepared food packages.

According to one or more embodiments, the server is further configured to include one or more of: a data center supporting a network system for vending custom-prepared food packages to customers from a plurality of kiosks, each kiosk comprising a computing device and an interface for communicating with the data center over the network system. The data center comprises: one or more data stores for storing inventory information corresponding to custom-prepared food packages in the plurality of kiosks, one or more modules for receiving the inventory information from the plurality of kiosks and processing the inventory information to control inventory in the plurality of kiosks, and a network interface for connecting to the network system, wherein the data center is configured to connect to network interfaces of the plurality of kiosks over a network.

Disclosed herein is a method. The method comprises receiving, from a computing device, an order for a first food package to be custom prepared. The method also includes transmitting, to a food preparation facility, the order for the first food package to be custom prepared. The method further includes tracking placement and position of the custom-prepared first food package in a storage rack within a vending kiosk, the kiosk configured for housing a plurality of custom-prepared food packages, each custom-prepared food package associated with a specific order received from a customer, the plurality of custom-prepared food packages positioned in the storage rack. The method additionally includes receiving, on a user interface, a selection of the first food package by a user; directing a controller coupled to a robotic arm located within the kiosk to engage the first food package at the storage rack and deliver the first food package to a product delivery area exterior of the kiosk; and verifying completion for the order.

According to one or more embodiments, the method further comprises processing a payment associated with the order prior to the first food package being loaded to the storage rack.

According to one or more embodiments, the method further comprises: reading an identifier on the first food package; looking up a stocking location associated with the identifier of the first food package in the storage rack; and communicating the stocking location to the robotic arm.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates a perspective view of an automated vending system including a storage rack according to one or more embodiments of the presently disclosed subject matter.

FIG. 2 illustrates a bottom perspective view of the automated vending system of FIG. 1 according to one or more embodiments of the presently disclosed subject matter.

FIG. 3 illustrates a side perspective view of a portion of a side chamber of the automated vending system of FIG. 1 according to one or more embodiments of the presently disclosed subject matter.

FIG. 4 illustrates a top plan view of the automated vending system of FIG. 1 according to one or more embodiments of the presently disclosed subject matter.

FIG. 5 illustrates a side perspective view of an automated vending system including food package deposition windows and a biometric device according to one or more embodiments of the presently disclosed subject matter.

FIG. 6 illustrates a perspective view of a robotic system for use in an automated vending system according to one or more embodiments of the presently disclosed subject matter.

FIG. 7 illustrates a front plan view of the storage rack for use in an automated vending system according to one or more embodiments of the presently disclosed subject matter.

FIG. 8A illustrates a front perspective view of a food package slot of the storage rack for use in an automated vending system according to one or more embodiments of the presently disclosed subject matter.

FIG. 8B illustrates a perspective view of a food package holder bar of the storage rack for use in an automated vending system according to one or more embodiments of the presently disclosed subject matter.

FIG. 9 is a block diagram of an example configuration of an application for use with an automated vending system according to one or more embodiments of the presently disclosed subject matter.

FIG. 10 illustrates a side perspective view of an automated vending system including food package deposition doors and a biometric device according to one or more embodiments of the presently disclosed subject matter.

FIG. 11 illustrates a partial side perspective view of a top side portion of an automated vending system including food package deposition door and a biometric device according to one or more embodiments of the presently disclosed subject matter.

FIG. 12 illustrates a partial top perspective view of a top portion of an automated vending system including food package deposition door and conveyors according to one or more embodiments of the presently disclosed subject matter.

FIGS. 13 and 13A are example configurations of an order processing module for use with an automated vending system according to one or more embodiments of the presently disclosed subject matter.

FIG. 14 is an example configuration of an inventory management module for use with an automated vending system according to one or more embodiments of the presently disclosed subject matter.

FIG. 15 is example configuration of an inventory management icon for use with an automated vending system according to one or more embodiments of the presently disclosed subject matter.

FIG. 16 is an example configuration of an automatic order creation (AOC) module for use with an automated vending system according to one or more embodiments of the presently disclosed subject matter.

FIG. 17 is an example configuration of an order basquet module for use with an automated vending system according to one or more embodiments of the presently disclosed subject matter.

FIG. 18 is an example configuration of a submitted orders module for use with an automated vending system according to one or more embodiments of the presently disclosed subject matter.

FIG. 19 is an example configuration of a confirmed orders module for use with an automated vending system according to one or more embodiments of the presently disclosed subject matter.

FIG. 20 is an example configuration of an order arrivals module for use with an automated vending system according to one or more embodiments of the presently disclosed subject matter.

FIG. 21 is an example configuration of a financial module for use with an automated vending system according to one or more embodiments of the presently disclosed subject matter.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

A typical vending machine vends products e stored within the machine. A typical vending machine may accept coins, paper currency and credit/debit cards. Vending machines are often placed where people gather, pass by, or wait, such as public buildings and transportation hubs including subways and airports, hospitals, schools, and similar other locations. In the common vending machine, after the appropriate number of coins or bill payment is made, and the good selected, the good is typically dropped or delivered into a built-in bin which is accessible to the customer for retrieving the product. Such vending machines are very limited to a few products, i.e., a very small selection. Typical vending machines are associated with selling high-sugar, low-nutrient snacks and drinks, such as candy bars, potato chips and soft drinks. Furthermore, the general layouts of vending machine, in most cases, are not appealing. In recent times, due to bad reputation (for dispensing unhealthy foods) and negative social stigma of vending machines are counted as some of the reasons that some consumers are avoiding the use of conventional vending machines. Furthermore, vending machines may not allow consumers to examine an item closely prior to purchase; they may not allow for the returning of an item back and reverse the sale. The sale process is thus unfriendly and upon vending the product each sale becomes final. Traditional vending machines also many not include goo security measures, other than tamper-proofing. Thus, pranksters and thieves can damage the vending machine, and in some cases remove the money deposited within the vending machine. There is no live twenty-four-hour surveillance of such vending machines.

In some corporate office settings, unattended micro-markets that provide items for sale are operated within a company's break room and offer food and beverages “off-the-shelf” using the honor system. In such micro-markets, consumers can pick up items off the open and unsecured shelves and then the consumers are required to scan the barcodes of each item at the barcode scanner located on the local automated computer kiosk. Such open shelf micro-markets are limited to only highly secured locations and are subject to losses due to theft. Therefore, such micro-markets must be located only within the company's break room or in such areas where the identity of the customers are known, and the potential theft is mitigated.

In company micro-markets and traditional vending machines, there is no real time communication between the consumer and the operator of the micro market or the vending machine, should problems or questions arise. The customer can attempt to call the operator of the micro-market or the vending machine, if the contact information of the operator is posted. Otherwise, more typically, the customer is unable to contact such operators during such visits to the micro-market or the use of the vending machine.

Therefore, under the current situation and in most cases, if an individual desires to have something to eat or drink which is more substantial or healthier than a candy bar, soda, etc., or desires to buy any personal, toiletries or conventional items, that individual must either find and purchase such products at a grocery store, a restaurant or other type of convenience stores. In other cases, there are gift shops, coffee shops or the like which may be placed in the lobby of hotels or buildings or within the waiting area of an airport which will offer such products. However, these are typically only open during limited hours of each day and require one or more people to be present to handle the purchases from the consuming public. Accordingly, there is a continuing need for automated checkout store outlets which feature an automated “off the shelf” selling method and system which is appealing and attractive and offers a wide selection of products.

Embodiments of the presently disclosed subject matter can advantageously provide for an automated vending system (alternately referred to herein as the “system”) that can offer better and more nutritious food than most vending machines without restriction to location or hours of operation. Embodiments of the presently disclosed subject matter can accordingly advantageously overcome several of the shortcomings associated with the current state of the art.

Embodiments of the presently disclosed subject matter relate to delivery of fresh custom prepared food to various customers including workers in an efficient manner. Embodiments of the presently disclosed subject matter can allow for delivery of fresh and delicious organic meals to the workforce. Various embodiments as disclosed herein can act as a mechanism of temporary storage and delivery specifically of pre-ordered and/or pre-paid food meals, cooked and delivered daily to a specific client location with a software platform seamlessly managing the process.

Various embodiments of the system as described herein can include a central kitchen to cook all meals as opposed to many restaurants with multiple kitchens. Various embodiments of the system include a software application 100 (alternately referred to herein as “application 100” or “FOMBOX 360”) for managing various aspects of the ordering and vending processes of the system as described herein, with the software application 100 including a front-end application 101 (also referred to herein as “front-end computing application” or “front-end mobile application”) that can operate on a computing device such as a smart phone and can be viewed and manipulated by a customer. The software application 100 further includes a back-end application 201 (also referred to herein as “back-end computing application” or “back-end mobile application” or “back-end platform”) for use by various stake holders that operate in coordination to manage the processes associated with receiving and fulfilling orders for custom-prepared food received from various customers. The application 100 can allow for automation of many time-consuming operational tasks, providing clients and customers with a front-end mobile application to order and pay for each meal to be delivered. Application 100 as described herein is configured to be scalable and operate at hundreds of kitchens. The back-end application 201 can allow for the management of the entire operation via a single platform providing a 360-degree view of the business environment. Back-end application 201 can be configured to handle all areas of the system including customer orders management, inventory management, purchase orders management and financials.

Accordingly, in various embodiments, the system can allow only food that has been paid for to be cooked and delivered at a kiosk, reducing waste and resources. The various embodiments further include a specifically designed kiosk (also referred to herein as “Food Dispensing Machine” or “FDM” of “FDM Box” or “FOMBOX”) that operates as a point of delivery (not a point of sale) for customers to retrieve their meals. The kiosk as described herein can be located at lobbies of office buildings, for example, thereby reducing food delivery costs and the environmental footprint associated with food delivery.

A typical vending machine dispenses a product to a consumer after a payment is made at the vending machine, with most food items not customizable to the requirements of the consumer. Further, a typical vending machine is designed to serve as a point of direct sales to the end consumer, requiring the customer to pay either by cash or via a credit card through the vending machine. By contrast, embodiments of the presently disclosed subject matter can require pre-payment before a customized meal or food item ordered by a consumer or customer is prepared at a food preparation facility.

According to various embodiments of the presently disclosed subject matter, the system allows a customer to order and pay for a custom meal (alternately referred to herein as “custom-prepared food package”) through an application running on a mobile device, and to choose a specific kiosk (among a plurality of kiosks managed by the system) to pick the ordered meal from. A central server of the system that is in communication with the mobile application receives the customer order and forwards the same to a food preparation facility such as a central kitchen, for example, prior to midnight. At the central kitchen, an order handling module of the software in communication with the server can segment, organize and group all received orders associated with custom-prepared food packages and assigns each food package a stocking location or slot on a storage rack of the kiosk. The prepared food packages are positioned in the storage rack according to the stocking location assigned by the order handling module. The storage rack is then transported to and positioned within the assigned kiosk. The customer associated with the order can retrieve the ordered custom-prepared food package by using a QR code provided by the server or a personal identification number (PIN) or similar other customized information supplied to the customer by the server. In various embodiments, the customer can receive notifications as soon as the specific food package ordered by the customer is loaded within the specified kiosk. The server can communicate with various components of the system, including the kiosk, wirelessly or through a wired connection.

In some embodiments, the food may not be prepared in a single food preparation facility or kitchen but rather prepared at a plurality of food preparation facilities. For example, the customer may select a certain food item from within a list of food items available from participating restaurants—based on information stored at the server. The order handling module in communication with the server can segment, organize and group all received orders for a plurality custom-prepared food package. Specifically, the module assigns each order to the relevant restaurant and creates a unique identifier for each food package or each meal. The unique identifier can be a QR code, a RFID, a bar code or a similar other technology that can be read by an automated imaging device or scanning device. The module can further assign each food package a stocking location or slot on a storage rack of the kiosk operated by the automated vending system. The restaurants then prepare the food packages and the module coordinates the loading of the food packages onto the storage of the assigned kiosk. The prepared food packages are accordingly positioned in the storage rack according to the stocking location assigned by the module. The storage rack is then transported to and positioned within the assigned kiosk. The customer associated with the order can retrieve the ordered food package by using a QR code provided by the server or a personal identification number (PIN) or similar other customized information supplied to the customer by the server. In some embodiments, the restaurants can be required to deliver the prepared meals (i.e., “custom-prepared food packages”) to the assigned kiosk or to an assigned storage rack or to an assigned slot of a storage rack prior to a predetermined time, for example, prior to 11 AM.

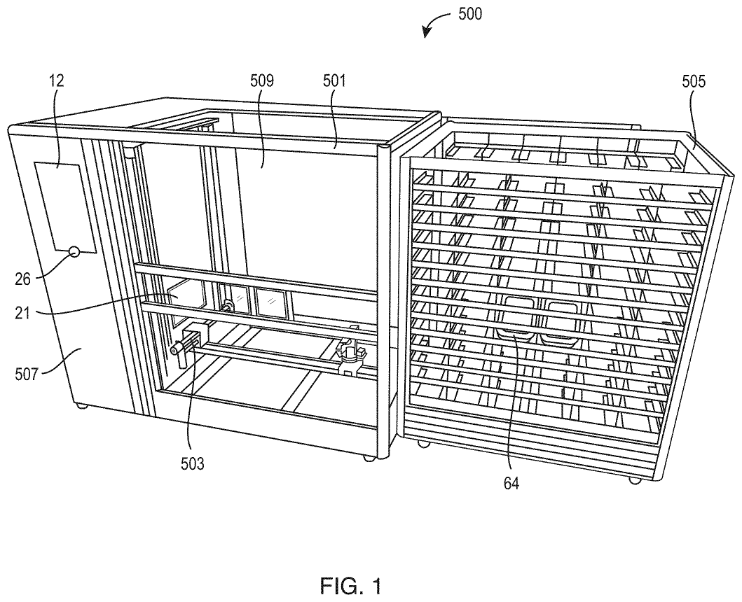

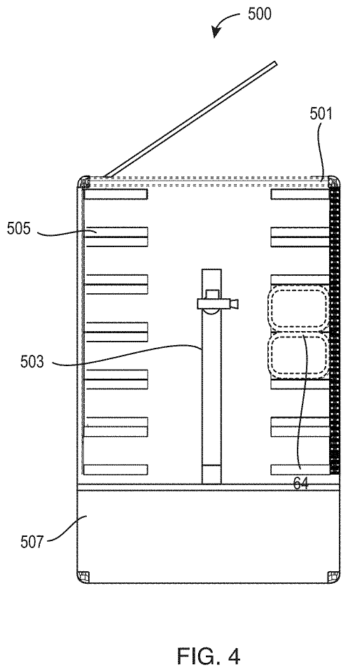

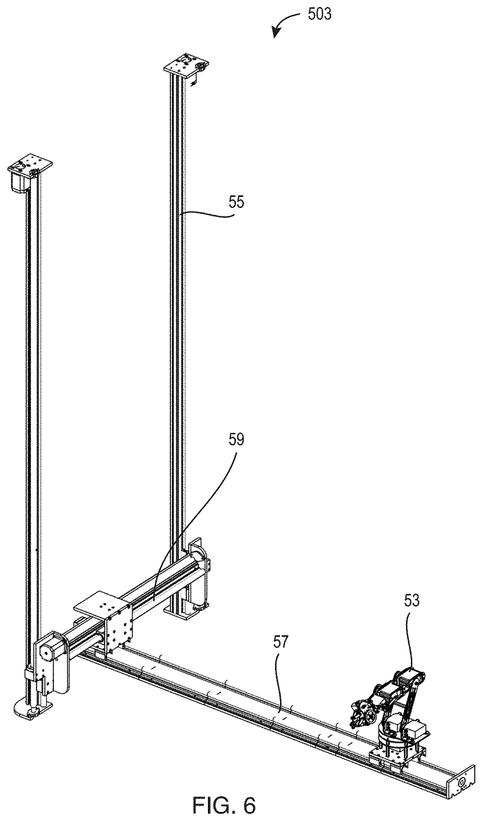

The server according to various embodiments of the presently disclosed subject matter can include a processor communicably coupled to at least one memory. The server can further include program instructions (for e.g., application 100) which when executed by the processor can cause the processor to receive, from a computing device, an order for a first food package to be custom prepared. In one embodiment, the computing device can be a mobile device such as a smart phone, for example, operated by a customer. The program instructions executed by the processor can further cause the processor to transmit, to a food preparation facility, the order for the first food package to be custom prepared. In one example, the food preparation facility can be a restaurant. The program instructions executed by the processor can further cause the processor to track placement and position of the custom-prepared first food package in storage rack 505 within kiosk 500, as illustrated in FIG. 1, for example. In one embodiment, the processor communicates with a controller, such as the controller present in kiosk 500, and robotic arm 53 of robotic system 503 (see FIGS. 4 and 6, for example) to accomplish the tracking placement and positioning of the custom-prepared food packages. In one embodiment, one or more modules of back-end application 201 operating on the controller can be in communication with back-end application 201 operating on the central server of the system as described herein.

Kiosk 500 as illustrated, for example, in FIG. 1 is configured for housing a plurality of custom-prepared food packages, each custom-prepared food package associated with a specific order received from a customer with the plurality of custom-prepared food packages positioned in storage rack 505 positioned within kiosk 500. The program instructions executed by the processor can further cause the processor to receive, on a user interface, a selection of the first food package. The program instructions executed by the processor can further cause the processor to direct the controller in communication with robotic arm 53 located within the kiosk to cause the robotic arm engage the first food package at the storage rack and deliver the first food package to a product delivery area of the kiosk; and verify completion for the order. In various embodiments, as part of engaging the first food package at the storage rack, an imaging device coupled to the robotic arm reads an identifier on the first food package. In further embodiments, directing the controller to cause the robotic arm to engage the first food package includes a lookup of a stocking location (on the storage rack) associated with the identifier of the first food package by controller or the robotic system and communication of the stocking location to the robotic arm. The program instructions can be executed at one or more of the central server and the controller, wherein the controller is coupled to, or otherwise forms an integral part of, the kiosk 500. In one embodiment, the program instructions can also be executed at a processor of the robotic system 503, wherein the robotic system 503 includes its own computing device. Accordingly, in some embodiments, robotic system 503 includes a processor, memory and a wireless transceiver. In various embodiments, the server is configured to communicate with the controller and the robotic system 503 over a wireless network. In various embodiments, the server is configured to communicate with a mobile application such as front-end application 101 operating on a mobile device associated with the customer. In some embodiments, the controller can be a digital controller that includes a processor, memory and a wireless transceiver, among other components.

In various embodiments, the central server (alternately referred to herein as “server”) is further configured to process a payment associated with the order. In other words, the server can allow a customer to place an order for a custom prepared food package and make a payment via a front-end application 101 (also referred to herein as the “front-end platform” or “mobile application”) operating on the customer's computing device. After the server receives the order and the payment for the order, the server can coordinate the preparation of the custom-prepared food package and the loading of the food package in a specific stocking location of a storage rack located within a specific kiosk 500. In some embodiments, the specific kiosk 500 can be picked by the customer; in some embodiments, the server can pick the specific kiosk 500 among several kiosks 500 where the customer can pick up the custom-prepared food package based on the customer's location or preferences, based on the information captured at the front-end application 101 (i.e., the front-end platform). In various embodiments, the kiosk or the infrastructure provided therein is not be provided with the ability to receive/process a payment associated with a customer order for a custom prepared food package.

In various embodiments, the server is further configured to include a data center or is configured to be in communication with a data center supporting a network system for vending custom-prepared food packages to customers from a plurality of kiosks, each kiosk comprising a computing device and an interface for communicating with the data center over the network system. The data center can comprise one or more data stores for storing inventory information corresponding to custom-prepared food packages in the plurality of kiosks, and one or more modules for receiving the inventory information from the plurality of kiosks and processing the inventory information to control inventory in the plurality of kiosks. The data center can further include a network interface for connecting to the network system, with the data center being configured to connect to network interfaces of the plurality of kiosks over a network.

In various embodiments, the kiosk 500 includes the following major components. The first main component is the structural box 501. The second component is a robotic system 503 including a robotic arm used to find and retrieve the specific meal box that pertains to the customer. This component is accommodated within structural box 501. The third and last main component is storage rack 505 designed to fit within structural box 501. In one embodiment, storage rack 505 is in the form of a portable cart (may also be referred to herein as “FDM Cart”) that can be rolled in and out of structural box 501. In one embodiment, food packages 51 (also referred to herein as “meals” or “meal boxes”) can be loaded onto storage rack 505 in the form of a portable cart at a food preparation place such as a generic kitchen or a restaurant and portable cart is then placed inside the FDM, to then have food packages 51 retrieved by robotic arm and placed in pick up window for customers.

In various embodiments, kiosk 500 form part of an automated vending system for pre-ordered custom-prepared food packages. Kiosk 500 is configured to house a plurality of custom-prepared food packages 51. Each custom-prepared food package 51 is associated with a specific order received from a customer. A plurality of custom-prepared food packages 51 are positioned in storage rack 505 within the kiosk. A robotic arm 53 located within the kiosk is configured to engage a first food package 51 from storage rack 505 and deliver the first food package 51 to a product delivery area of the kiosk. In embodiment, first food package 51 is delivered at meal pick up window 14 provided with a sliding door, whereby the customer can pick up the food package 51 after the sliding door opens. The sliding door opens when sensors detect that a meal has been placed at or near the product delivery area of the kiosk. In one embodiment, the robotic arm 53 places the first food package 51 at a food package slot 61. The automated vending system further includes a user interface to allow selection of the first food package. In one embodiment, the user interface is in the form of an interactive screen 12. The kiosk further includes a controller configured to command the robotic arm 53 to select and deliver the first food package 51 to the product delivery area represented by food package slot 61.

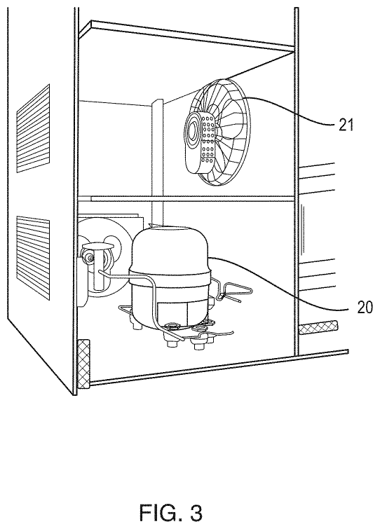

In various embodiments, as shown, for example, in FIG. 3, the kiosk further includes an air conditioning and humidity control system 20 that can include a refrigeration device for cooling the food packages and a humidity control device for maintaining proper humidity levels within an enclosed interior area of kiosk 500. The kiosk can also include microwave heating device 22 for heating or reheating the first food package. In various embodiments, the controller present in the kiosk is further configured to track stocking locations of each of the plurality of custom-prepared food packages through the controller coupled to the kiosk, the controller in communication with the central server.

In some embodiments wherein the food packages to be loaded to the storage rack are delivered at the food package deposition window 28, the controller instructs the robotic arm to pick up the food package delivered at deposition window 28 and load them onto the storage rack; in such embodiments, the storage rack may or may not be in the form of a portable cart. Accordingly, in some embodiments, the kiosk is provided with one or more “vendor” windows (i.e., food package deposition windows) wherein a vendor may first be validated through biometrics, and granted access to begin loading of food packages within the kiosk, with the robotic arm operating to place the food packages in corresponding locations on the storage rack; this can conveniently preclude the need for a vendor to directly access the storage rack within the kiosk.

In various embodiments, a payment associated with the first food package is received prior to the first food package 51 being loaded to the storage rack 505. In various embodiments, an order for the first food package 51 is received prior to the first food package 51 being loaded to the storage rack 505.

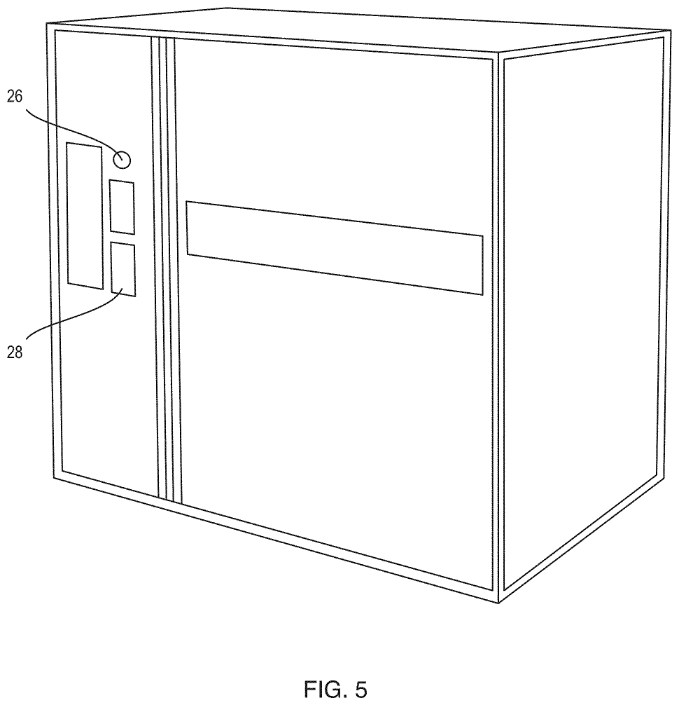

In some embodiments, the kiosk is configured for the custom-prepared food packages to be uploaded into the kiosk without requiring a person to open and enter the kiosk; food package deposition windows 28 (see FIG. 5, for example) can facilitate the loading of food packages onto the storage racks without opening the kiosk door. After a deposition window 28 is opened and a vendor places a custom-prepared food package into a food package receiving platform located within the kiosk that is accessible through the opened deposition window 28, the robotic arm 53 can couple with the food package and move it to a designated slot on storage rack 505 within the kiosk, the slot designation supplied by the server or by the controller present on kiosk 500. The kiosk can further include fingerprint (biometric) recognition capabilities in the form of biometric device 26 to allow a user such as a vendor to “deposit” food packages into the kiosk via the two deposition windows 28 onto the food package receiving platform. The kiosk can further include a mechanism to ensure the security and verification of the food packages being loaded into the kiosk.

As illustrated in FIGS. 1 to 5, kiosk 500 can include components such as interactive screen 12, meal pick up windows 14, servo motors for operating sliding windows 14, sensors connected to servo motors 16, air conditioning and humidity control systems 20, microwave heating device 22 with QR code readers, automatic utensil dispenser 24 and biometric device 26 for granting access into an interior of the kiosk for loading food packages, for example. Accordingly, in various embodiments, a user interface such as an interactive screen 12 is positioned on an outer surface of the kiosk, wherein the user interface comprises an interactive LED (light emitting diode) display. Interactive screen 12 can conveniently allow customers to scan QR code or enter PIN to retrieve their meal and advertisement. In one embodiment, interactive screen 12 can be a LED screen. Interactive screen 12 may comprise a small screen next to deposition windows 28 for a vendor of food packages to enter information such as details on the food packages being loaded within the kiosk. Interactive screen 12 may be interactive serving as a medium of communication between the vendor and the server, for example, for resolving issues such as error loading meals, un-identified barcode read, and similar other situations. Biometric device 26 can include a fingerprint reader in one embodiment such that after a vendor's fingerprint has been scanned and approved, food package deposition windows 28 may open to permit deposition of food packages.

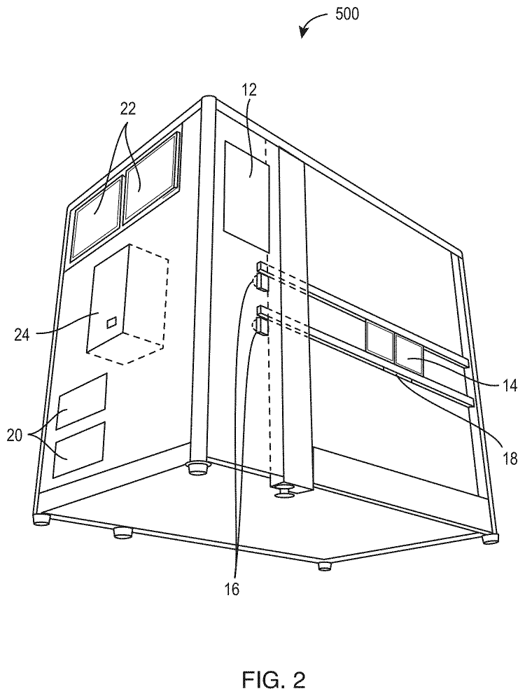

Windows 14 provide access for retrieval of the ordered food package by a customer. In one embodiment, there may be two windows each measuring 152 mm (6″) in height by 172 mm (6.7″) in width, with automatic closing doors. Servo motors 16 operate to automatically open and close the sliding doors of the window. In various embodiments, the wiring associated with the servo motors and siding doors can be provided within the top and bottom aluminum rails as shown in FIG. 2. Short range sensors 18 operate to detect when the robotic arm has placed a food package at or near the windows 14 for retrieval by the customer, and send signals to servo motors 16 to open and close the sliding windows, as needed. In one embodiment, each sensor 18 may have sensing range of less than six inches radius so it does not pick up movement from robotic arm.

As shown in FIG. 3, kiosk 500 can also include air conditioning and humidity control systems 20 to maintain the food packages within the kiosk at optimal conditions. In one embodiment, with air conditioning and humidity control systems 20 is enclosed within side chamber 507, with one or more through wall openings 21 provided on a side wall of side chamber 507 for air flow from air conditioning and humidity control systems 20 to main chamber 509 containing the food packages. As shown in FIG. 3, in one embodiment, a fan may be provided at a through wall opening 21 for circulating air into main chamber 509. Kiosk 500 further includes one or more microwave heating devices 22 for warming food packages dispensed by the kiosk. In one embodiment, each microwave oven is provided with scanner or QR code reader such that only food packages dispensed by kiosk 500 may be warmed the microwave oven. Kiosk 500 can also further include an automatic utensil dispenser 24 to be used by customers retrieving food packages from the kiosk. Kiosk 500 can further include a biometric device 26 positioned at a convenient location on the outer surface of the kiosk. Biometric device 26 is configured to provide different level of access depending the individual's specific access configuration as determined by a central server or a controller residing on kiosk 500 (hereinafter referred to as “kiosk controller” or simply “controller”). For example, device 26 may provide a food supplier the ability to load food packages within the kiosk; it may provide a quality control inspector needed access to determine whether the food packages stored within the kiosk meet predetermined standards of quality. The server or controller may be configured to store all activity occurring at device 26.

In various embodiments, robotic arm 53 is configured to move back and forth along a channel such as static horizontal guide 57 extending within the kiosk for placing or retrieving food packages onto or from the storage rack. As shown in FIG. 6, robotic system 503 includes robotic arm 53, static vertical guides 55, dynamic horizontal guide 59, and dynamic horizontal guide 59. Robotic arm 53 is configured to move back and forth about static horizontal guide 57. Static horizontal guide 57 is configured to move laterally sideways in the left and right direction about dynamic horizontal guide 59. Dynamic horizontal guide 59 is configured to move up and down about static vertical guides 55. Robotic system 503 application can be controlled by the kiosk controller operating on the kiosk. In various embodiments, the kiosk controller is in communication with the central server.

In various embodiments, a QR code reader, a bar code reader or similar other scanning or imaging device is coupled to robotic arm 53. The reader, scanner or imaging device can advantageously scan and read a unique identifier attached to embedded on a food package, whereby a stocking location of the package can be stored by the controller coupled to a memory or at the server coupled to a memory. Accordingly, robotic arm 53 can include one or more of a QR code reader, a RFID reader, a scanner, and an imaging device configured for interacting with an identifier on the first food package. In various embodiment, the unique identifier can be a QR code, a RFID, a bar code or a similar other technology that can be read by an automated imaging device or scanning device. Accordingly, the controller can store the unique identifiers of each of the food packages, and the robotic arm in communication with the controller can place a food package in a particular location of the storage rack 505 after the scanner or imaging device of the robotic arm scans the unique identifier on the food package. Similarly, the robotic arm in communication with the controller can pick a food package from a particular location of the storage rack 505 after the scanner or imaging device of the robotic arm scans the unique identifier on the food package, and the robotic arm can deliver the picked food package to the food package slot 61 of the kiosk so that a customer associated with the food package can retrieve the food package via a meal pick up window 14. Accordingly, in various embodiments, the plurality of custom-prepared food packages can be loaded onto the storage rack by the robotic arm precluding the need to open a side door of the kiosk for loading the food packages onto the storage rack.

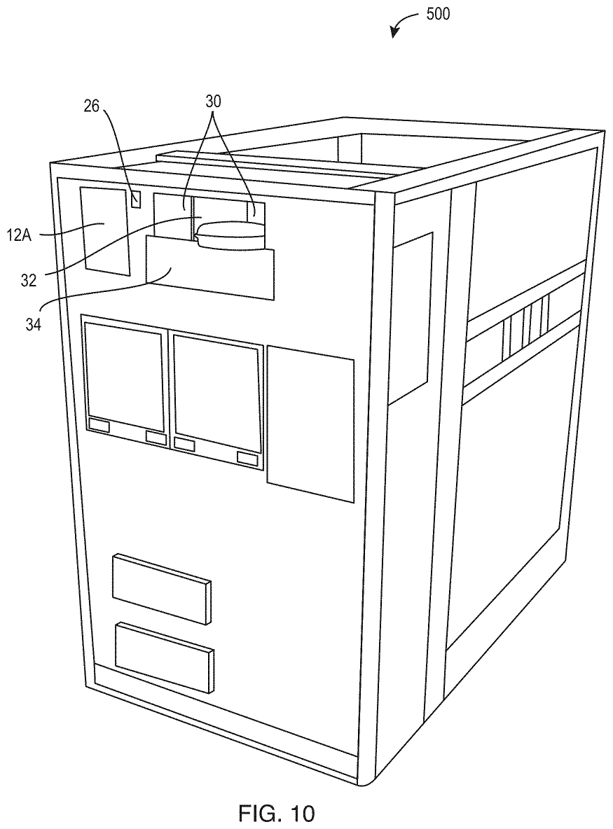

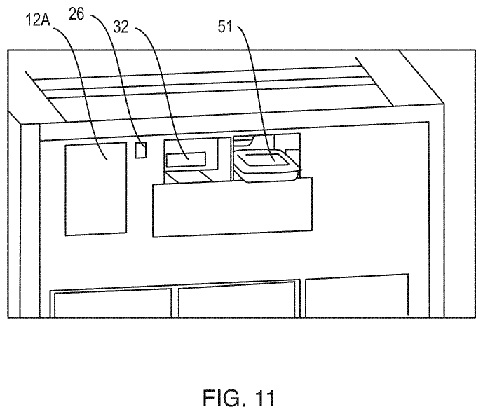

FIGS. 10 to 12 illustrate another embodiment of the presently disclosed subject matter according to one or more embodiments of the presently disclosed subject matter.

As shown in FIGS. 10 to 12, kiosk 500 can further include a side interactive screen 12A, biometric device 26 located on the side of the kiosk for granting access to a vendor to load food packages within the kiosk, food package deposition apertures 30 provided with doors 32 that secure the apertures, and protective cover 34. Accordingly, in various embodiments, side interactive screen 12A represents a user interface positioned on an outer side surface of the kiosk for use primarily by vendors. Side interactive screen 12A can comprise an interactive LED (light emitting diode) display in some embodiments. Side interactive screen 12A can conveniently allow a vendor or a delivery person associated with the vendor to access the automated vending system at the kiosk to process the uploading of food packages into the kiosk. Side interactive screen 12A can also serve as medium of communication between the system/server and the delivery person for resolving issues such as, for example, error loading meals, un-identified barcode read, and similar other issues.

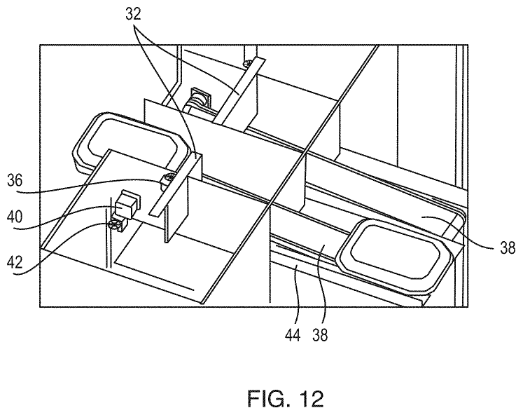

As shown in FIG. 12, servo motors 36 are provided for opening/closing doors 32 that secure food package deposition aperture 30. Conveyor belts 38 operate to move/transport a food package placed by a vendor at food deposition aperture 30 to an interior location of the kiosk where robotic arm 53 can engage the food package and transfer it to a predetermined food package slot 61 of storage rack 505 located within kiosk 500, with servo motors 40 provided for operating conveyor belts 38. Servo motors 42 are provided for operating protective cover 34. Metal arms 44 are provided to hold food packages delivered by conveyor belts 38 where the robotic arm 53 can engage the food package and transfer it to a predetermined food package slot 61 of storage rack 505 located within kiosk 500.

Biometric device 26 can include a fingerprint reader in one embodiment such that after a vendor's fingerprint or a delivery person's fingerprint has been scanned and approved, servo motors 36 operate to open doors 34 that secure food package deposition apertures 30. In addition, servo motors 42 can operate to slide protective cover 34 down in order that the process of scanning food packages to be loaded into the kiosk can proceed. Each kiosk 500 can be provided with one, two or more food package deposition aperture 30. Each food package deposition aperture is provided with its own conveyor belt 38 and servo motors 40 to operate conveyor belts 38 to load the food packages into the kiosk. A QR code reader, a RFID reader, a scanner, and an imaging device configured for interacting with an identifier on the food package can be provided at or near each door 32 for scanning/reading the identifier on the food package for validating each food package before it could be loaded into the kiosk. After validation, the delivery person is permitted to place the validated food package on top of conveyor belt 38, which is conveyed to metal arm 44. Robotic arm 53 can pick up the validated food package from metal arm 44 and place it at a predetermined food package slot 61 of storage rack 505 located within kiosk 500. In various embodiments, door 32 opens only after the bar/QR code on the food package is read and validated. This process is repeated for each food package so as to validate each item that is being “deposited” into the kiosk. Accordingly, in various embodiments, door 34 validates the delivery person, whereas door 32 validates each food package being deposited.

In various embodiments, storage rack 505 in the form of a mobile cart is provided with one or more alignment mechanisms that cooperatively couple with complimentary structural mechanisms provided within structural box 501 to ensure that storage rack 505 is positioned in proper alignment to ensure proper loading and unloading of food packages from storage rack 505. In one embodiment, the complimentary structural mechanism provided within structural box 501 may be a rod or pin that inserts into the alignment mechanism on the storage rack in the form of a cooperating opening for accommodating the rod or pin, with an optional sensor provided contiguous to the rod or pin that can provide feedback (sound, visual, etc.) regarding whether or not the storage rack 505 is properly positioned within kiosk 500.

Storage rack 505 can be further provided an auxillary wheel mechanism positioned about two inches above ground level that can operate to protect the storage rack from damaged resulting from the storage rack bumping into obstructions as storage rack 505 is carted from a truck to the interior of the kiosk.

In some further embodiments, the side of the storage rack facing the front of the kiosk may be provided some empty spaces that are void of food package slots 61 and/or food package holder bars 63 to allow clear visibility of robotic arm 53 as it moves to place and pick up meals. This provision can provide an artistic, esthetic, or otherwise appealing enhancement whereby the general public may be able to view the operations of the robotic arm 53 in action as it loads and unloads food packages from the storage rack 505, for example, through a transparent wall portion of the kiosk.

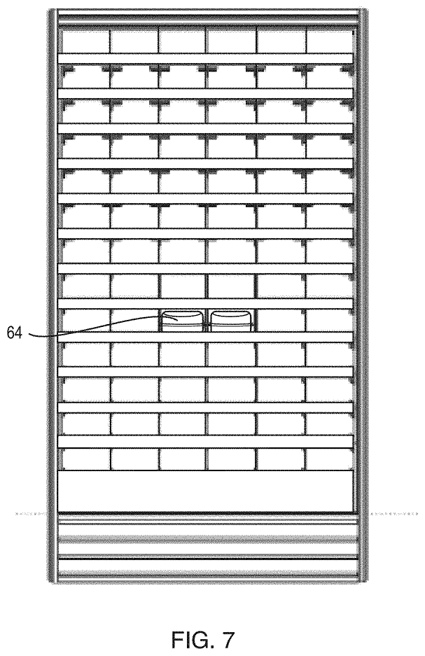

Referring to FIG. 7, a portion of the front facing side of storage rack is shown. As shown in FIG. 7, the storage rack includes a food package pick up area 64. The location of food package pick up area 64 aligns with the location of windows 14 such that when the sliding doors on the windows 14 open, a customer can pick up a food package place in the area 64 by the robotic arm 53.

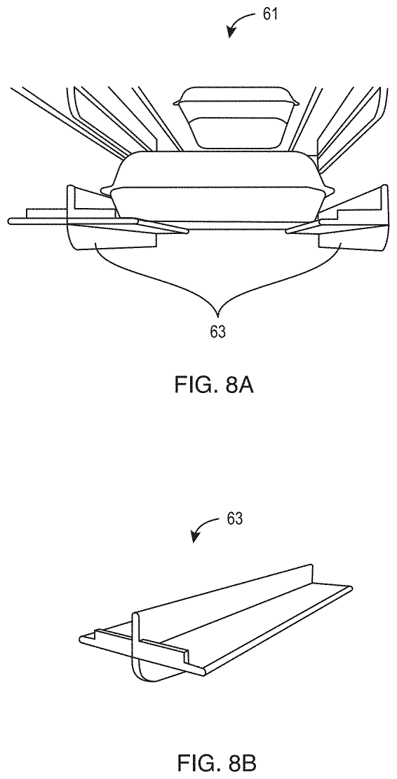

As shown in FIGS. 1, 8A and 8B, storage rack 505 includes a plurality of food package slots 61 for receiving and hold food packages 51. Each food package slot 61 includes food package holder bars 63 configured for conveniently receiving food packages 51 and retaining them for robotic arm 53 to pick them up and deliver at area 64 for retrieval by a customer associated with the food package. The food package slots 61 are configured to accommodate food packages of different sizes. The “U” shape design an allow for a clamp of robotic arm 53 to safely grab the food package, lift it and retrieve it; the slot's design can further prevent the food package from falling off while the package is being handled while being loaded onto the storage rack or being retrieved from the storage rack. Locating food package slots 61 in the middle of the storage rack can provide minimize the time it takes the robotic arm to grab and “deliver” a food package. Further, providing at least two slots as opposed to only one allows for the robotic arm 53 to continue work on delivering a second package while a customer is retrieving a first package, thereby further minimizing the turnaround time required for fulfilling several orders received during a busy period around lunch time, for example.

In various embodiments, each of the custom-prepared food packages within kiosk 500 includes one or more organic food items. In one embodiment, the plurality of custom-prepared food packages is loaded onto the storage rack from an opening at or near a top surface of the kiosk. In some embodiments wherein the storage rack is in the form of a portable cart, the cart can be rolled into the kiosk after the cart is loaded with food package.

In some embodiments, the kiosk is designed such that that all food packages will be loaded on the mobile storage rack at kitchen or food preparation facility and then the mobile storage rack carted to and positioned inside the kiosk. In other embodiments, a third party vendor or a delivery person can load food packages through a vendor window such as food package deposition windows 28 provided on the front the kiosk (see FIG. 5, for example). In further other embodiments, a third party vendor or a delivery person can load food packages through a vendor window such as food package deposition aperture 30 on the side of the kiosk (see FIG. 10, for example).

According to various embodiments of the presently disclosed subject matter, a method comprises receiving, from a computing device, an order for a first food package to be custom prepared. The central server or the automated vending system can execute, monitor and control the method. The computing device can be a smart device such as a smart phone, for example, or a desktop computer. The method further includes transmitting, to a food preparation facility, the order for the first food package to be custom prepared. The transmitting can occur wirelessly or through a wired connection. The method further includes tracking placement and position of the custom-prepared first food package in a storage rack within a vending kiosk. The controller as described herein can perform this function in some embodiments; in others, the server in communication with the kiosk in general or with the controller in particular can perform this function. The kiosk is configured for housing a plurality of custom-prepared food packages, each custom-prepared food package associated with a specific order received from a customer, the plurality of custom-prepared food packages positioned in the storage rack. The method can further include receiving, on a user interface, a selection of the first food package; directing a controller coupled to a robotic arm located within the kiosk to engage the first food package at the storage rack and deliver the first food package to a product delivery area exterior of the kiosk. In some embodiments, the user interface can be located on an outer surface of the kiosk. In some embodiments, the user interface can be in the form of LED screen. The method also includes verifying completion for the order. The verification can be done either by the server or by the controller. The method can also include processing a payment associated with the order prior to the first food package being loaded to the storage rack.

In various embodiments, the method can further include reading an identifier on the first food package by an imaging device or scanner located at the kiosk that is separate from the imaging device or scanner couples to the robotic arm.

The method can further include looking up a stocking location associated with the identifier of the first food package in the storage rack, and communicating the stocking location to the robotic arm. The robotic arm may then move close to the stocking location in the storage rack and pick the food package or otherwise couple to the food package, and deliver the food package to food package pick up area 64 of kiosk 500.

In various embodiments, the kiosks as described herein may not process payments associated with orders for custom prepared food packages; accordingly, the receipt of payments as well as the processing of payments may be performed electronically by the server for payment authorizations received from customers via a front-end mobile computer application such as front-end application 101. Accordingly, in some embodiments, the kiosk may not include a mechanism for receiving and processing of payments from customers.

In various embodiments, the kiosks as described herein can be configured to include the following capabilities: (1) hold and deliver at least 152 unique food packages (e.g., 176 or more unique food packages); (2) a refrigeration system; (3) a built-in microwave to allow heating or reheating of the food packages; (4) mechanism and associated software to permit a customer to quickly retrieve a specific custom-prepared food package ordered by the customer; and, (5) integrate seamlessly with the system and software as described herein that offers both a front-end application 101 (customer facing) and back-end application 201 to process thousands of orders for customized food packages and integrate the entire business model into a single platform to allow for automation of tasks. In various embodiments, the food packages as described herein can be in the form of meal boxes, with the size and shape of the meal boxes configured for ease of handling by the robotic arm.

In some embodiments, the kiosk is configured to occupy a small footprint, for e.g., of 28 square feet. In some embodiments, the entire FDM kiosk can have approximate measurements of 1792 mm (70.5 inches) in length, 1094 mm (43 inches) in width, and a height varying between 1461 mm (57.5 inches) and 1830 mm (72 inches). In one embodiment, the kiosk can be approximately 6″ longer that the typical kiosk as described herein and can include two small windows next to the screen area. However, these measurements are in no way limiting, the size and shape of the FDM kiosk configured as dictated by a particular application.

In operation, the server receives an order for one or more items via an electronic communications medium. The server then assigns the order to a food preparation center. The server then tracks the loading of a custom prepared food package associated with the order onto the storage rack of a kiosk. Later on, when a customer associated with the order arrives at the kiosk and informs the server, system or controller that the customer is interested in retrieving the food package, the server or the controller or the server in collaboration with the controller will inform the robotic arm of the stocking location of the food package on the storage rack. The robotic arm then moves close to the stocking location, picks up the food package, and delivers the food package to the food package pick up area 64. Then servo motors 16 operate to open the sliding doors to expose the food package through meal pick up window such that the customer can retrieve the food package. Sensors 18 detect that the food package has been placed at the food package pick up area 64, and this information is communicated to servo motors 16, which proceed to operate to open the sliding doors to expose the food package through meal pick up window such that the customer can retrieve the food package. The robotic arm accordingly retrieves the order automatically and presents it to the customer through a meal pick up window 14. After the customer retrieves the food package, the server and/or the controller may then update front-end application 101 with “order picked up” status for that particular order, which completes the order cycle. Additionally, in one embodiment, when an order has been fulfilled (e.g., has been picked up by the customer), inventory management module 207 automatically deducts all the corresponding ingredients associated with that particular food item to ensure that the system does not approve an order that cannot be fulfilled by the system.

In various embodiments, the server further includes a tracking system configured to track locations of the inventory of the plurality of custom prepared food packages, wherein the tracking system further tracks respective stocking locations within the storage rack of each of the food packages stored within each of the plurality of kiosks managed by the server.

In some embodiments, each of the plurality of custom prepared food packages is prepared at a central kitchen, i.e., at a single location rather than at several food preparation facilities. Accordingly, the plurality of custom-prepared food packages is prepared at the centralized food preparation facility. In various embodiments, after orders associated with each of the plurality of custom prepared food packages is received and processed by the server, the custom prepared food packages may be prepared at the central kitchen.

In various embodiments, after payments associated with the orders for each of the plurality of custom prepared food packages is received and processed by the server, the custom prepared food packages may be prepared at the central kitchen. Indeed, according to various embodiments, potentially no two packages loaded onto the storage rack need to be same.

The robotic arm is configured to place and retrieve food packages 51 based on unique identifiers associated with each of the plurality of custom-prepared food packages. The server, in collaboration with the controller operating on kiosk 500, is configured to select a first food package at the kiosk through use of a first identifier associated with first food package, wherein the selection of the first food package causes a lookup of a first stocking location of the first food package within the storage rack and a communication of the first stocking location to the robotic arm to select the first food package.

In one embodiment, food packages can be loaded onto storage racks without the need to open a side door of the main chamber 509. In other words, some embodiments provide for the loading of food packages onto the storage rack through food package deposition windows 28 provided on the outer surface of kiosk 500. Deposition windows 28 represent openings for receiving food packages. In one embodiment, each opening can include a conveyor belt (for e.g., as explained with respect to FIGS. 10 to 12) that is accessible by robotic arm 53. The robotic arm is configured to scan an identifier on the food package, and may already be provided a first stocking location on the storage rack associated with the identifier; the robotic arm may then couple to the food package and move it to the designated first stocking location assigned to that specific food package. In one embodiment, the openings may lead to a flat surface that does not include a conveyor belt, and the robotic arm may be configured to couple to the food package placed on that flat surface and move it to the designated first stocking location assigned to that specific food package.

A barcode scanner positioned on the inside of kiosk near deposition windows 28 may then scan each food package as it is deposited by the vendor; in another embodiment, the scanner coupled to robotic arm 53 may perform this function.

In some embodiments, the storage rack 505 is configured to accept up to 170 unique food packages. In some embodiments, storage rack 505 in the form of a cart can include tires than ride over bumps. In some embodiments, storage rack in the form of a cart also includes a coupling mechanism at its corners such that it can connect to the receiving point within the kiosk 500; this mechanism can conveniently allow the storage rack to remain stable and in an upright position within the kiosk 500.

Kiosk 500 can be advantageously filled with custom prepared food packages including one or more organic food items. In various embodiments, the food is pre-ordered and pre-paid prior to the food package being loaded onto the storage rack of the kiosk. The kiosk can support up to 170 food packages or more, with each of these food packages being unique in that the kiosk can hold 170 food packages associated with 170 different and unique food orders processed by the server; in other words, potentially no two packages need to be same.

Various embodiments of the presently disclosed subject matter can advantageously provide for receiving orders related to custom prepared food packages, preparing and delivering the custom prepared food packages to a plurality of kiosks managed by the central server.

In some embodiments, a kiosk as disclosed herein can be located within a corporate building. The system and method as disclosed herein may include built-in security features such as cameras, infra-red or similar other scanners, and similar other security features to identify any tampering with the kiosk or with the food packages. Embodiments of the presently disclosed subject matter can accordingly provide an automated kiosk with the ability to store and deliver to customers a unique custom food order.

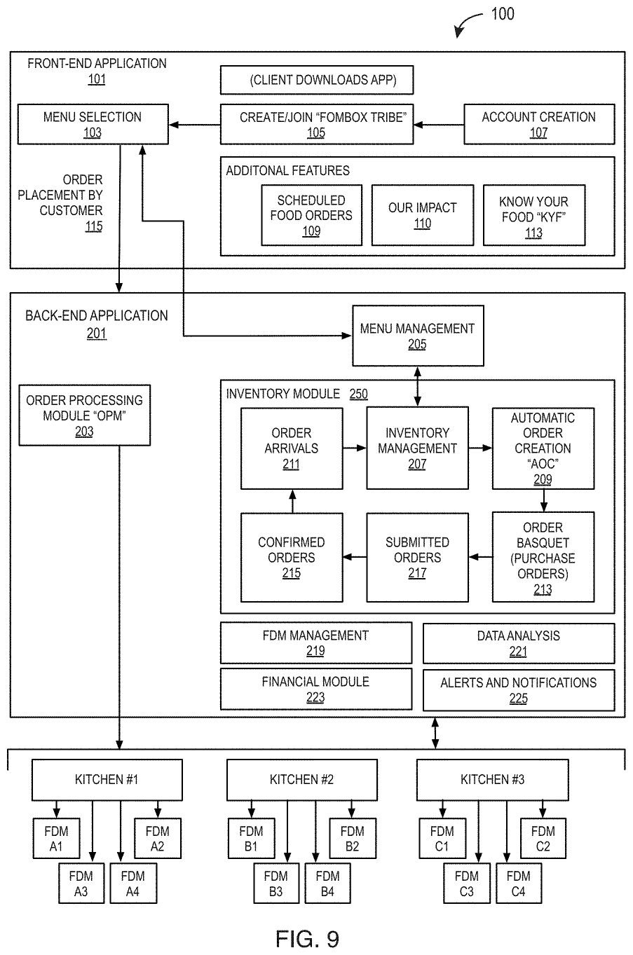

Now the system and server operations will be described in detail. In various embodiments, the system includes front-end application 101 operating on a mobile device that is tied to back-end application 201 operating on the server (i.e., both the front-end application 101 and the back-end application 201 can form part of the same single application 100, with server application in two-way communication with the front-end mobile application. In other words, both the front-end mobile application and server application can be two aspects of the same front-end application 101. In various embodiments, the server is further configured to include a data repository tracking the stocking locations of each of the plurality of custom-prepared food packages based on a unique identifier associated with each of the plurality of custom-prepared food packages. The system has described herein may include an application 100 operating on the server, on a user's computing device and similar other systems that include a processor and a memory, and the computing application controllable by the system can alternately be referred to herein as “front-end application”, “FOMBOX application”, or “back-end application”. Front-end application 101 and back-end application 201 form part of application 100, as illustrated in FIG. 9. The server may include a server software such as back-end application 201 operating therein (also referred to herein as “back-end platform”) that is configured to communicate with a customer-facing front-end application 101 (also referred to herein as “front-end platform”) operating on a client device such as a mobile device operated by the customer or user.

As illustrated in FIG. 9, the system can include front-end application 101 comprising several modules in communication with each other. In one embodiment, the front-end application 101 operating on a customer or user computing device (also referred to herein as “front-end platform” or “FOMBOX application”) can include modules such as a menu selection module 103, create/join “FOMBOX tribe” module 103, account creation module 107, schedule food orders module 109, our impact module 110 and know your food “KYF” module 113. After a customer undertakes the step of placing an order 115 for a custom prepared food package, this order is received by back-end platform module 201.

Menu selection module 103 can include the following features. The default screen display of menu selection module 103 may display favorite items based on the user's prior preferences of the user of the front-end application 101 on a computing device. The favorite Items listed may be sorted by most ordered meal to least ordered meal. The favorite items can have a maximum listing of 8 items, in one embodiment. Module 103 can include a sub-tab that allow chefs from various kitchens using the kiosk system as described herein to create and offer their own unique dishes, which may change by season or region. Module 103 may further include sub-tabs grouped by categories, proteins, wraps, salads as well as a “custom” section where the user can compile a custom meal by choosing from all of the available ingredients. Module 103 can further include a “Sold Out FDM” or “Sold Out Meal” sub-tab that will automatically provide nearest available FDM to place order, when the FDM picked by the user does not carry or a food processing facility cannot supply that specific meal.

Account creation module 107 can include the following features. Account creation module 107 can provide the ability to create a profile, including name and phone number validation. It can further provide the ability to enter meal pick address or zip code, which might prompt the display of a map with nearest FDM to choose from. A “default” FDM can be chosen. Account creation module 107 can also provide for the entering of form of payment such scan credit card or payment with crypto currency. It can also include a “Love & Hate” sub-tab that allows the user to search and add ingredients that the user loves and keeps tracks of ingredients that the use hates to help user quickly prepare the user's customized meal. This information can further serve as a filter for front-end application 101 to discard meals options that include ingredients that the user hates and recommend meals that include ingredients that the user loves. Account creation module 107 can further include account management features that provide for modifying or otherwise managing account, payments, alerts, and similar other items.

Create/join “FOMBOX Tribe” module 105 can include the following features. It can provide the ability to create or join an existing group coined “FOMBOX Tribe”. Joining a “FOMBOX Tribe” will allow a user to invite others to join their “FOMBOX Tribe”; it will further provide the user with the ability to receive message via SMS. In various embodiments, the “allow access to contacts” option can be set mandatory in order to invite people; accordingly, front-end application 101 is configured to recognize whether some is an existing user or a newly joining user. Create/join “FOMBOX Tribe” module 105 can further provide a user/customer with the ability to send a “join” link to new users and existing users. It can further provide newly joined users the ability to earn free meal credits after such new users download and install the front-end application 101 of application 100 on a computing device. Free meal credits may be earned only after a new user makes a purchase. Create/join “FOMBOX tribe” module 105 can further include a “PUMM PLS” (for “Pick Up My Meal Please”) function, which provides the ability to a first user that ordered a meal and/or made a payment towards a meal to assign a second user from the same “tribe” to pick up the first user's ordered meal. Upon acceptance by application 100, the second user can automatically get an order pick up code associated with the first user's ordered meal from the server. Create/join “FOMBOX Tribe” module 105 can further provide the ability to donate a meal whereby if one of the members of the group has ordered a meal but cannot pick up the ordered meal, that member can “donate” the meal to their group in general or to an individual within group. Upon accepting the “donation”, the user accepting the “donation” can be provided with that order's pick-up code by the back-end platform application 201.

Scheduled food orders module 109 can include the following features. Scheduled food orders module 109 can provide the ability to create a repetitive order for predetermined days of the week, for e.g., every Tuesdays and Fridays. It can further provide the ability to pre-designate a specific meal for each chosen day, for e.g., Tuesdays: chicken & quinoa, and Fridays: Tofu and veggies. It can further include a “Meal Basquet” feature where by a “Meal Basquet” can be created automatically by application 100 by choosing the type of meals that the user likes, and application 100 can also randomly choose a meal from the “Meal Basquet” to automatically fulfill an order for the user on days when the user is scheduled to pick up a meal from the FDM or kiosk. Scheduled food orders module 109 can further include a “scheduled meal notification” feature whereby the user can receive a push notification such as, for e.g., “Your FOMBOX meal, chicken & quinoa, is confirmed for tomorrow; to change meal or to postpone to a different day or to next week click here”.

Know your food (“KYF”) module 113 can be designed to provide users with insight and relevant information on the types of foods available for ordering through application 100. Know your food (“KYF”) module 113 can include information on the process used to cook the meals, where the ingredients were sourced from, and the route taken by the ingredients from their point of origination to their final destination. It can further include a “meet your food” feature that can present all major ingredients found in the various meals. Each major ingredient is presented as an icon, and within the icon sub icons are provided, the sub icons providing information such as where the ingredient came from, and health benefits accruable from the ingredient with a breakdown of main vitamins and nutritional value, among others. Know your food (“KYF”) module can further include an “abracadabra” feature that can provide information on how the ingredients get converted into the custom-ordered food, including a graphical display of the process and methodology involved in cooking a given meal.

Our impact module 110 can be designed to quantify all of the environmental and social benefits achieved as a result of supporting the FOMBOX model controlled by the server through application 100. It can include an “environmental footprint” feature that provides graphical views and analytics associated with scientifically supportable results that compare organic food consumption versus conventional food consumption, and can include information on the approximate figures on the pesticides and herbicides reduced, in addition to similar other information. Our impact module 110 can further include a “your carbon footprint reduction” graph that calculates the difference in the average carbon footprint between a meal individually delivered by a delivery person to the user location versus when the meal bought by the user through the FOMBOX application where more than 150 meals get delivered at one go, which has the potential to reduce food delivery carbon footprint by over 95%. Our impact module can further include a FOMBOX Foundation feature that provides a summary of an overall positive environmental impact of the FOMBOX system.

Back-end platform module 201 operates to prepare, and update menu availability based on in-stock inventory items. When an order arrives, module can operate to immediately deduct inventory items accordingly. As shown in FIG. 9, Back-end platform module 201 can include modules such as order processing module 203, menu management module 205, inventory module 250, FDM management module 219, data analytics module 221, financial module 223, and alerts & notifications module 225.

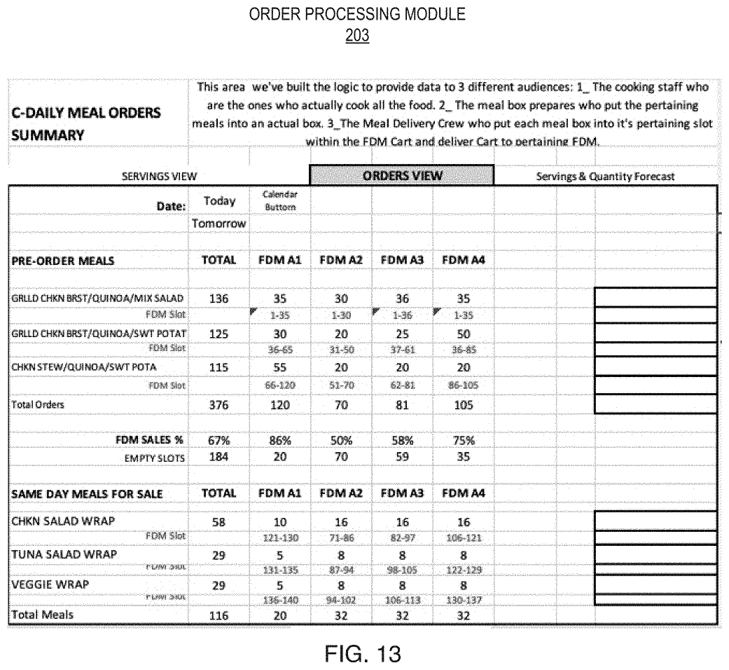

FIGS. 13 and 13A illustrate example configurations of an order processing module 203 as viewed on a graphical user interface of a computing device, according to one or more embodiments of the presently disclosed subject matter. Order processing module 203 of back-end application 201 can include custom logic to process all customer orders, and provide graphical and table interactive views of the received orders. It can further provide views such as: (1) daily servings & quantity summary; (2) servings & quantity forecast; (3) daily meal orders summary; and, (4) same day menu configuration. Order processing module 203 can further provide a view of all pertaining information associated with all received food package orders for view by food preparation facility staff and restaurant staff in an interactive fashion through a client-side module of application 100 operating on a computing device (i.e., front-end application 101) that is linked to application 100 operating on the server. Order processing module 203 can further create workflow logic that allows for the most efficient means for the staff to prepare, cook, and load meal boxes (i.e., food packages) onto the storage racks of respective FDM kiosks. It can further provide a servings and quantity summary sheet. This area can be used primarily by the food “preparers” that prepare the food items that the cooks then put together into a meal. The servings and quantity summary sheet is designed to show the total quantity per item that would be required for fulfilling all of the meal orders to be prepared on a given day. It can further provide the capability to mark each prepared food item as “completed”. It can also include a “servings & quantity forecast” feature that is similar to the “servings & quantity summary” table—except that—instead of using data representing customer orders, it is based on data taken from the “daily average item consumption” (“DAIC”) table/metric for each inventory item. It can further include a “daily meal order Summary” feature that can provide data to 3 different audiences: (1) cooking staff who are the ones who actually cook all the food; (2) meal box preparers who put the prepared meals into an actual meal box or food package; and (3) meal delivery crew who put each meal box or food package into a proper location on a FDM Cart and deliver the FDM cart to the relevant kiosk or FDM.

Menu management module 205 can include aspects such as (1) creating and modifying menu items; (2) managing menu display, and (3) pricing/editing menu items. Menu management module 205 is further configured to display an “existing menu” that provides the ability to view existing menu items for management or restaurant staff's view (this view may be similar to how menu items appear on the front-end application facing customers) and see pricing information, ingredients, and cost to prepare the meal. It can further include a “create new menu” option that provides the ability to create new menus to be displayed to customers on the front-end application by choosing ingredients stored within the inventory module. This can also create a structure for proper inventory deduction as food packages are ordered and/or sold via the application 100. It can further include a “menu pricing” feature that provides the ability to price individual menu items or “package” menu items; it can further for custom “build-your-own-meal” packaging, for e.g., chicken breast+two sides for $13.99. It can further provide a “modify menu” feature whereby management or staff can modify any menu pricing, or modify inventory ingredients that make up that menu item.

As shown in FIG. 9, menu management module 205 communicates with inventory module 250. Inventory module 250 can include sub-modules such as inventory management module 207, automatic order creation (“AOC”) module 209, order basquet module 213, orders module 217, confirmed orders module 215 and order arrivals module 211.

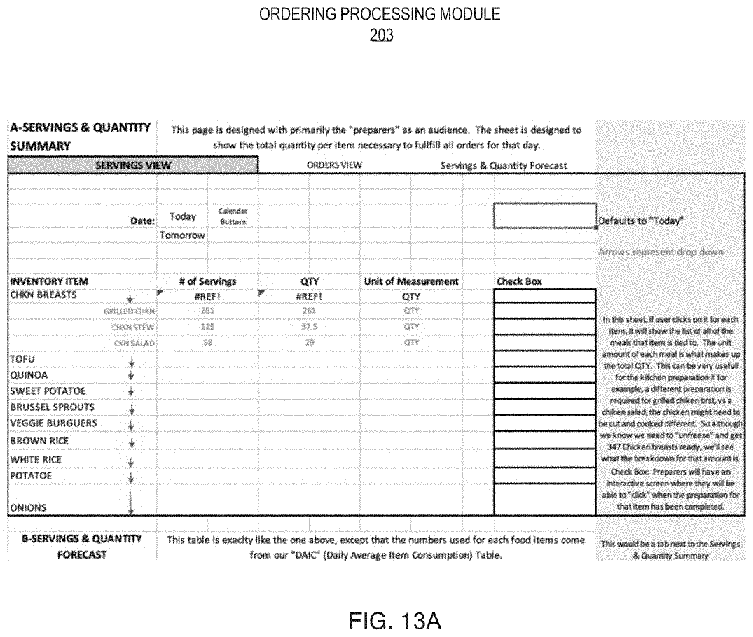

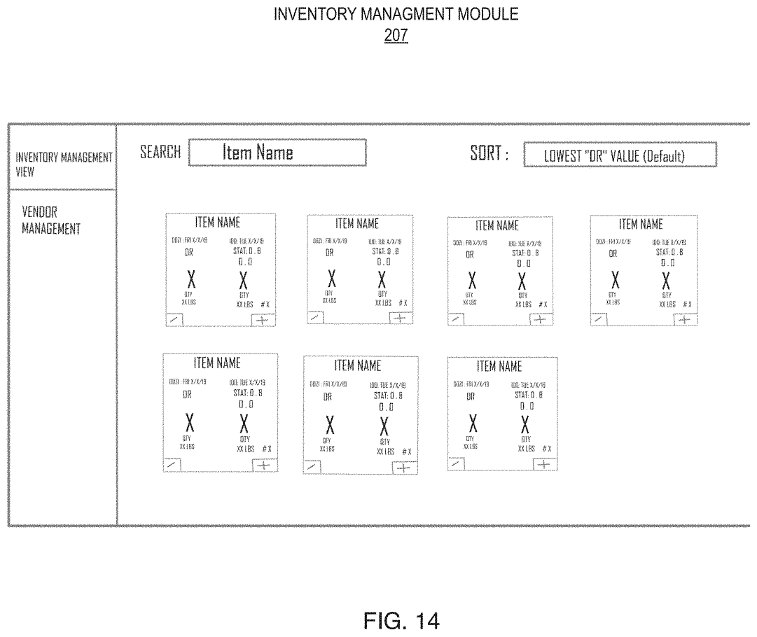

FIG. 14 illustrates an example configuration of an inventory management module 207 as viewed on a graphical user interface of a computing device, according to one or more embodiments of the presently disclosed subject matter. Inventory management module 207 can include a “creation & management of all inventory items” tab, a “create vendor profiles for pertaining inventory items” tab, a “view current available inventory in stock” tab, a “view current purchase orders pending arrival” tab, and a “instant inventory item deduction as orders take place” tab, among others. It can further include the ability to provide necessary metrics/data for the automatic order creation module 209. Inventory management module 207 can also operate to create and edit new inventory items, and suppliers of such inventory items. FIG. 15 is an example of an inventory management icon according to one or more embodiments of the presently disclosed subject matter. An interactive inventory icon as illustrated in FIG. 15 can provide information about two different processes in one place, current inventory and inventory orders. In addition, the icon can provide the ability to place manual orders and to see the status of new orders that have been placed, including expected date of arrival, date of zero Inventory (“DOZI”) and days remaining until a specific inventory item is expected to run out (“DR”). As noted, it can provide the ability to add/modify inventory quantities. It can further provide the ability to track lost and expired inventory, notifying management regarding lost, stolen or damaged inventory. It can further provide for the generation of “daily average item consumption” or “DAIC” metric. This metric can be used on several functions and features. For example, with the “DAIC” metric, a calendar driven inventory item consumption record table and DIAC calculation table by date range table can be generated. Inventory management module 207 can also provide for the creation of additional useful metrics including “MDWI” (minimum days' worth of inventory), “DTA” (days to arrival), “DR” (days remaining), “DOC” (date of order creation), “IDD” (item delivery date), “OIA” (out of inventory) alert, “DOI” (days out of inventory), “UOA” (un-submitted order alert), and “UCOA” (unconfirmed order) alert, among others. These additional metrics can be used for automating different functions within application 100. Inventory management module 107 can further provide for the creation of a process and flow map for all purchase orders from beginning to end, and can include automation, alerts and quality control measures.

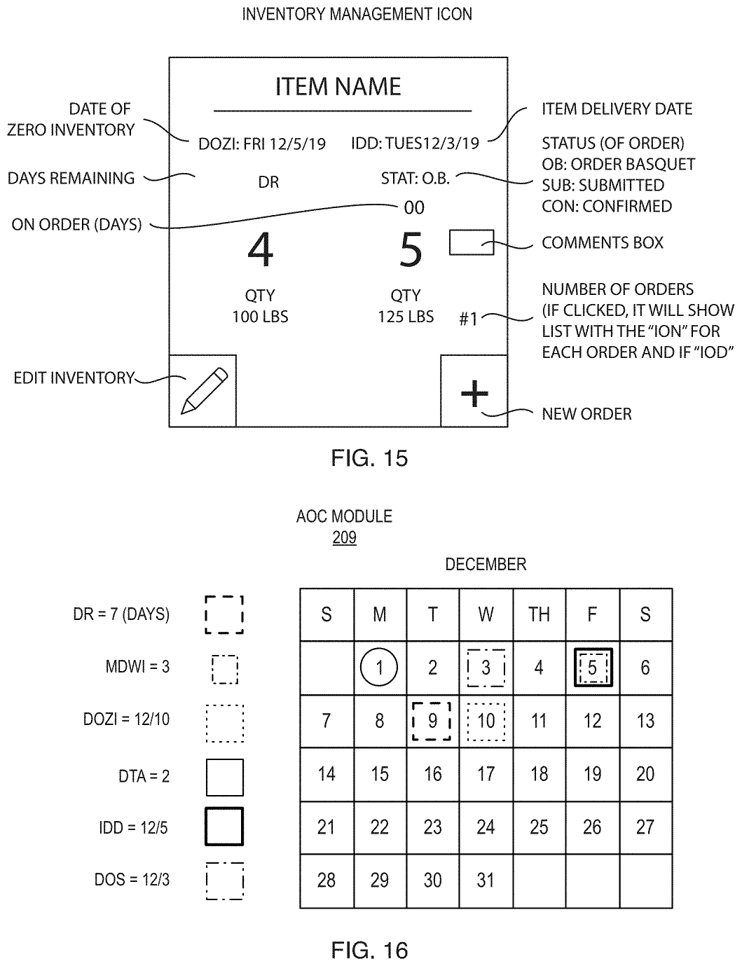

FIG. 16 illustrates an example configuration of an AOC module 209 as viewed on a graphical user interface of a computing device, according to one or more embodiments of the presently disclosed subject matter. The AOC module 209 can provide for the automation of the process of replacing inventory using established metrics and logic to create and send orders to order basquet module 213. Inventory management module 207 can feed other modules such as AOC module 209; AOC module 209 in turn can feed order basquet module 213; order basquet module 213 in turn can feed submitted order module 217; submitted order module 217 in turn can feed confirmed orders module 215; confirmed orders module 215 in turn can feed order arrivals module 211; order arrivals module 211 in turn can feed inventory management module 207 closing the entire cycle.

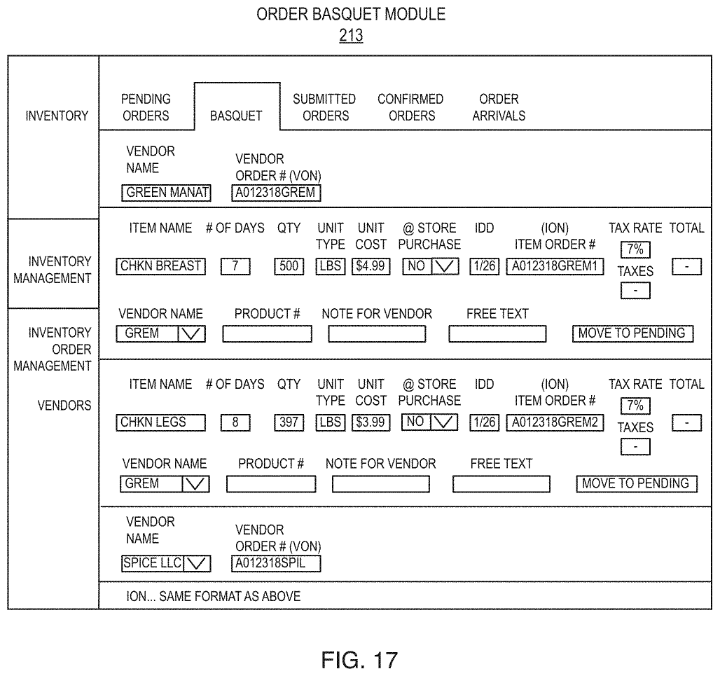

FIG. 17 illustrates an example configuration of order basquet module 213 as viewed on a graphical user interface of a computing device, according to one or more embodiments of the presently disclosed subject matter. The order basquet module 213 can provide for all orders created by an automatic order creation (“AOC”) module 209 to be consolidated and segmented by date and vendor. It can further provide for verification of all orders by a manager and submission of the same to vendors through the system as described herein. A “VON” (vendor order number) and “ION” (item order number) can be created using module 213 for proper tracking of each received order. Order basquet module 213 can further submit data to “submitted orders” tab of submitted orders module 217, which stacks all incoming meal orders to validate order details with vendors and adjust orders if necessary. This tab can further validate the arrival of all items including, quantity and condition, with the items being added to the inventory after validation. Order basquet module 213, optionally in conjunction with menu management module 205, can further include an “order arrivals” tab where all confirmed orders can be displayed, grouped and sorted by the respective item's delivery date (IDD).

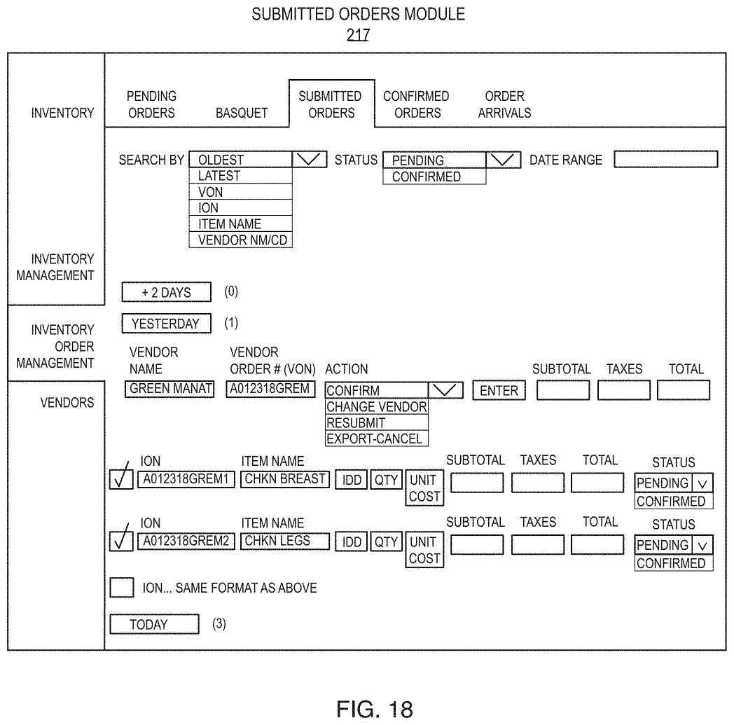

FIG. 18 illustrates an example configuration of submitted order module 217 as viewed on a graphical user interface of a computing device, according to one or more embodiments of the presently disclosed subject matter. Submitted order module 217 also referred to as “orders module” provides for the ability of sorting of submitted orders by chronological date and reviewing of the same by management. Submitted order module 217 can operate to confirm the item delivery date (“IDD”) as well as the quantities with the associated vendor. Any needed adjustments can made at submitted order module 217, and vendors can confirm their ability to fulfill their respective orders via submitted order module 217. Submitted order module 217 can further include a “confirmed orders” page or tab wherein all confirmed orders can be tracked. Alternately, or in addition to this, menu management module 205 can also include this information. Menu management module 205 can allow for payment information to be added, which can then be fed to the financial module 223. Orders coming in from AOC module 209 can grouped based on vendor at submitted order module 217. Based on the incoming orders, “VON”, “ION”, and “IDD” information are created. Orders are reviewed and submitted or moved to “pending orders” status. Submitted orders can be sent directly to a vendor via email or e-fax. Submitted order module 217 can include six custom metrics (“MDWI”, “DR”, “DOZI”, “DTA”, “IDD”, and “DOC”) that automate the process of creating a purchase order. The inbuilt logic can track consumption of various items and can be triggered by the “DO” (date of creation) data, whereby the logic will create the order so that the item arrives on time to the kitchen based on pre-established parameters. Orders can be automatically sent to the order basquet module 213 for final review and for further processing.

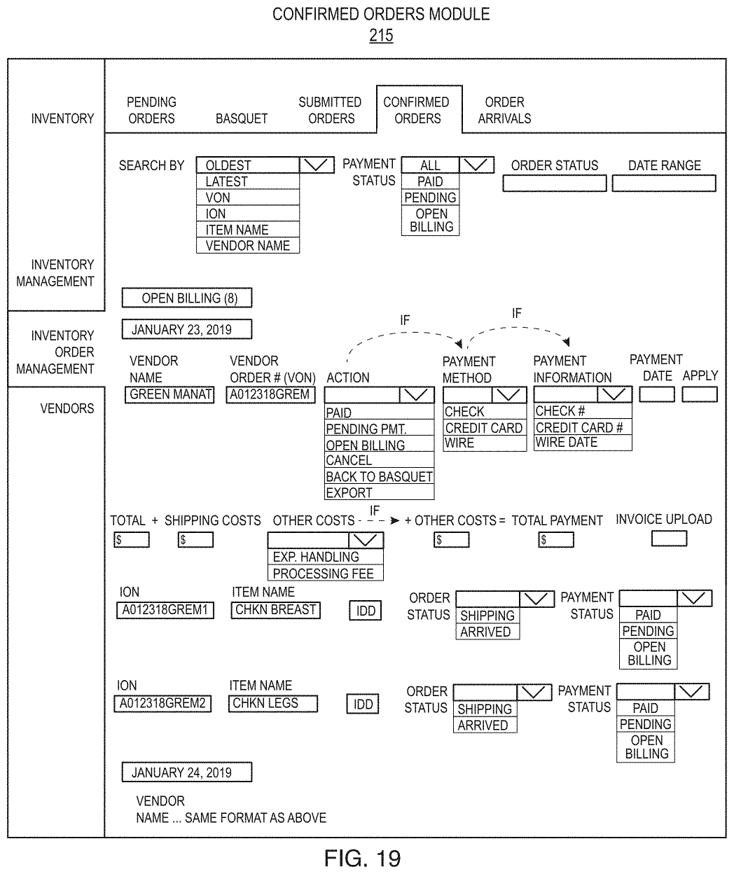

FIG. 19 illustrates an example configuration of confirmed orders module 215 as viewed on a graphical user interface of a computing device, according to one or more embodiments of the presently disclosed subject matter. Confirmed orders module 215 can provide the ability to view all confirmed orders. It can further provide the ability to collect payment related data, including storing of receipts. Confirmed orders module 215 can further have the ability to categorize information based on payment status and provide necessary data for financial review and tracking. Confirmed orders module 215 can further provide the capability to “search” orders by different metrics, such as by VON, ION, etc., or by payment or order status.

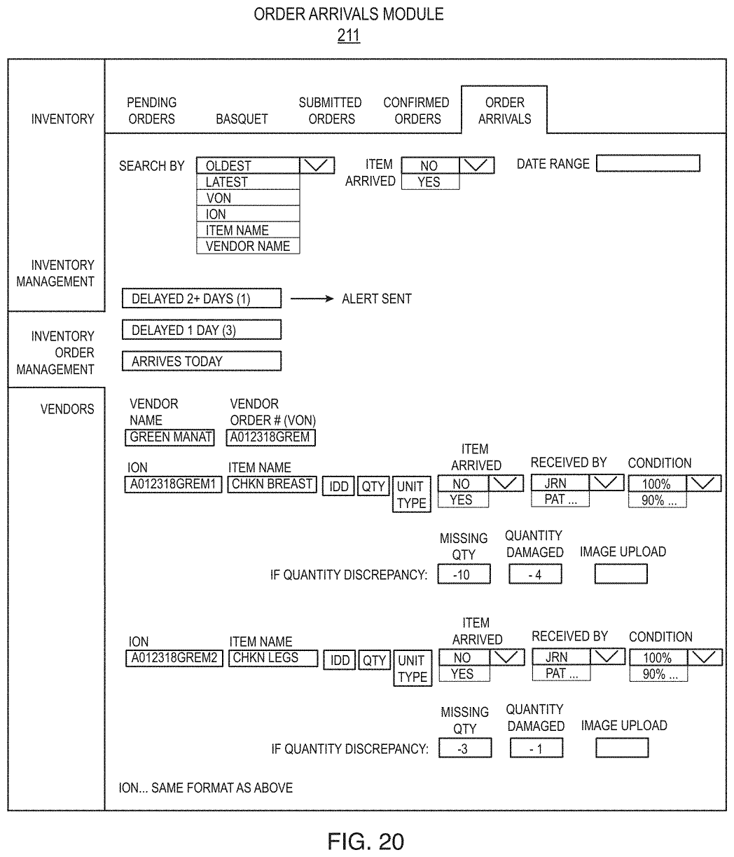

FIG. 20 illustrates an example configuration of order arrivals module 211 as viewed on a graphical user interface of a computing device, according to one or more embodiments of the presently disclosed subject matter. Order arrivals module 211 can operate to provide the ability to view all orders based on arrival dates. It can further provide for alerts when orders are delayed. It can also include a quality control process to document condition of inventory at arrival, including damaged inventory and missing quantities. Tracking of damaged inventory can require the uploading of pictures to prove damage. Order arrivals module 211 can further notify vendor and confirm whether items have been added to inventory. It should be noted that once an inventory item is marked as “arrived”, that inventory item and corresponding quantity gets added to the “current inventory” and is moved over to “inventory management” under “current inventory”. The cycle begins all over again when more of the same item arrives again or a new/different item arrives.

As shown in FIG. 9, back-end application 201 can further include the following four other modules for coordinating with kitchens, restaurants and kiosks 500 namely FDM management module 219, data analytics module 221, financial module 223, and alerts and notifications module 225.

FDM management module 219 can operate to create and assign new FDMs to kitchens, track all FDM activity, and to provide status and alerts. It can further generate unique identification for each Food Dispensing Machine (FDM) (i.e., kiosk 500) and also provide and store a geographical location associated with each FDM. It can further provide for FDM assignment whereby it allows each FDM to be assigned to a specific kitchen for corresponding order processing and delivery. It can further provide for management of FDM capacity since each FDM has a maximum number of food packages that it can store at any given time. FDM management module 219 can further operate to collect data on daily activity at each FDM (i.e., kiosk) including data associated with meals retrievals and meals not retrieved. FDM management module 219 can further provide for the ability to view the status of every FDM within the system for aspects such as FDM on, FDM off, FDM on track maintenance, and FDM internal temperature and humidity, among others. FDM management module 219 can further generate an alert when the internal temperature at an FDM falls outside of a predetermined temperature range.

Data analytics module 221 can supply business key performance indicators (KPIs) in simple and interactive dashboards for various departments such as sales, inventory, and overall business health. Data analytics module 221 can further display customer analytics that provide information such as number of new customers, number and percentage of repeat customers, usage trends for the front-end application, and time of orders, among others. It can also provide for inventory analytics including cost of good trends, loss of inventory, and similar other inventory related analytics. It can further include financial analytics including sales cycles, sales trends, sales forecasts, top selling items, most profitable selling items, vendor analytics, top vendors

The system may further provide for an optional reporting module that provides more detailed reporting capabilities that include similar information as provided by the data analytics module 211 but with additional details and reporting formats. For example, it can include financial reports with details on totals, top sale items, detail inventory reports, and detailed daily order reports for the whole system.

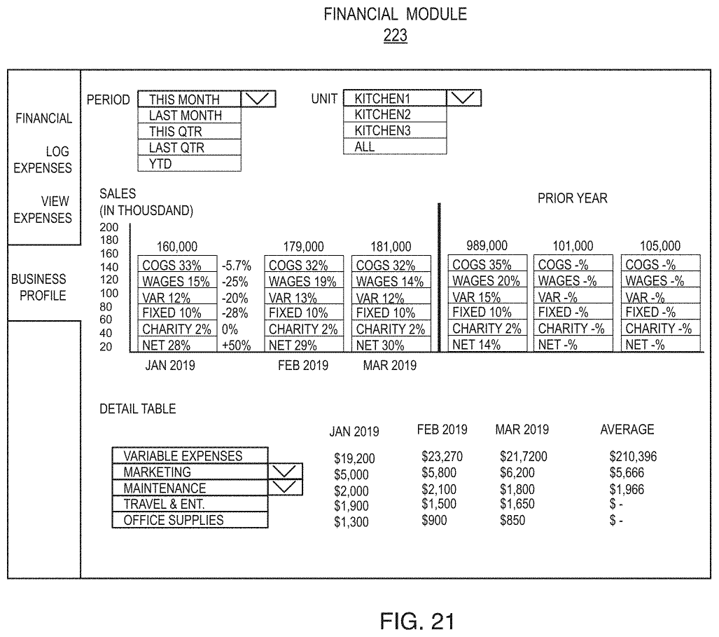

FIG. 21 illustrates an example configuration of financial module 223 as viewed on a graphical user interface of a computing device, according to one or more embodiments of the presently disclosed subject matter. Financial module 223 can provide for features such as logging, categorizing and tracking of all company expenses. It can be capable of extracting all financial data for subsequent uploading to the accounting system. Financial module 223 can further provide for graphical profit and loss displays for each of the food preparation facilities or kitchens. Financial module 223 can accordingly create and log all expenses into a single module, including variable and fixed costs, wages and charities. Cost of goods sold information can be brought in from the inventory order system or the inventory management module 207. A user will have the ability to quickly view all expenses and filter by expense category, type, form of payment and/or date range. It can also include a “Business pulse” feature that is an interactive graphical view showing the total sales for any time period, segmented by each expense category including variable, fixed, wages, cost of goods sold, charities, bonuses, etc. to provide net gain amount/percentage and a corresponding year over year percentage change showing the change of current period versus last year, as well as a details table for deeper analysis.

Alerts and notifications module 225 provides for automatic alert notifications for all business metrics as it relates to each area. It can include custom built notification rules that are triggered based on certain conditions. For example, alerts can be generated for every order that is in an “unconfirmed” or “pending” for more than a predetermined time interval. Alerts can also be triggered in circumstances such as: an order or item within an vendor order is in “pending” status for more than two days; an order or item that is two or more days past its “IDD” metric; items with “quantity discrepancy” or “damaged” status; and, an order with a “pending” status for more than 24 hours, among others. The alerts may further be augmented by email notifications.

As shown in FIG. 9, order processing module 203, in addition to FDM management module 219, data analytics module 221, financial module 223, and alerts and notifications module 225 can operate to coordinate with kitchens #1, #2 and #3 and various kiosks or FDMs including FDM A1-A4, FDM B1-B4, and FDM C1-C4.

The system can further include a third-party integration tool that provides for a parallel platform that uses the entire infrastructure and process of the system as described whereby member restaurants can be able to sell through the system as described herein. Each of the member restaurant users of the FOMBOX application will have a separate tab to access these restaurants menus and pricing, as well as order deadlines as determined by restaurant. Participating restaurants will have access to the platform associated with the system as described herein, receive all customer orders, and fulfill all orders and deliver orders to each pertaining FDM within a specific time window. Each meal may include a unique “barcode” sticker, and the member restaurants will have the ability to print and attach the associated sticker to each meal prepared for the restaurant for uploading to FDM operated by the system as described herein. In some embodiments, each delivery person will need prior approval and biometrics (fingerprints) taken prior to being granted access to the FDM. Once access is granted, each meal will be scanned and validated prior to robotic arm “accepting” a meal box. Once the server confirms that a meal box associated with an order has been positively stocked in a stocking location of storage rack at a specific kiosk or FDM, the customer associated with that order can be notified by the application 100 or by front-end application 101 that the customer's meal has arrived at the FDM and is available for retrieval.

Each of kitchens #1, #2 and #3 can then proceed as follows. Preparers at each kitchen can use tables and graphs to view and confirm all daily servings and quantities. Cooks can use meal orders summary data to plan and cook all meals. The meal box or food package preparers can then put together each meal box or food package. The food delivery team can then transport the prepared meal boxes or food packages and have them placed on a corresponding meal slot (i.e., stocking location) within each FDM cart for ultimate retrieval by the associated customer.

In various embodiments, a blockchain protocol can be used by the system for tracking and confirmation of inventory items purchased and used. This can advantageously provide a mechanism for proofing the source of the food ingredients used in the preparation of the food packages. For example, the blockchain protocol can provide the ability for a customer to identify where an organic food ingredient was sourced from, and whether the vendor supplying the food ingredient is indeed an organic certified vendor. In various systems, the blockchain protocol can be integrated with the system whereby various vendors can enter information related to blockchain tracking associated with the food preparation and food package delivery processes.

In various embodiments, the central server can provide for the use blockchain technology to store an online ledger of transactions associated with food ingredient procurement, with every new block generated required to be verified by the ledgers of all relevant parties, making it almost impossible to forge transaction histories. In various embodiments, the blockchain technology to be incorporated with the system as described herein can be an extension of a “public” blockchain with open application programming interface (API) that provides for the integration of food ingredient tracking. Vendors of core ingredients that go into the food preparation can integrate their product details into the blockchain system to thereby record and track all transactions associated with these food ingredients. The system can further provide for a web-page as part of the front-end application 101 that displays all relevant transactions as tracked by the blockchain technology operating on the server. Such a set up can advantageously provide a public interface whereby a customer can view relevant details for all major food ingredients. Some details such as price information may not be omitted from the information available for public viewing. Accordingly, in various embodiments, the system as described herein can allow for the integration of a single blockchain or multiple blockchains that can advantageously allow customers to “verify” relevant transactions associated with the food ingredient supply chain.

The various components of the system according to the exemplary embodiments may be embodied in a program command form which may be executed through various computer units and recorded in computer-readable media. The computer-readable media may contain program commands, data files, data structures, and combinations thereof. The program commands recorded in the medium may be specially designed for the exemplary embodiments. Alternatively, the program commands may be well-known by those skilled in computer software. The computer-readable media may include hardware devices specially configured to store and execute program commands. For example, magnetic media, such as a hard disk, a floppy disk and a magnetic tape, optical media, such as a CD-ROM and a DVD, a magneto-optical media, such as a floptical disk, a ROM, a RAM and a flash memory may be used as the computer-readable media. The program commands may include a machine language prepared by a compiler and a high-level language code prepared by an interpreter so as to be executed by a computer. The above-mentioned hardware devices may be configured to operate as one or more software modules to operate the exemplary embodiments and vice versa.

Although a few exemplary embodiments have been shown and described, it would be appreciated by those skilled in the art that changes may be made in these exemplary embodiments without departing from the principles and spirit of the invention, the scope of which is defined in the claims and their equivalents.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the presently disclosed subject matter.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. An automated vending system for pre-ordered custom-prepared food packages, comprising:
a kiosk for housing a plurality of custom-prepared food packages, each custom-prepared food package associated with a specific order received from a customer, the plurality of custom-prepared food packages positioned in a storage rack within the kiosk;
a robotic arm located within the kiosk, the robotic arm configured to engage a first food package from the storage rack and deliver the first food package to a product delivery area of the kiosk;
a user interface configured for receiving a user selection of the first food package;
a controller configured to command the robotic arm to select and deliver the first food package to the product delivery area.

2. The system of claim 1, wherein a payment associated with the first food package is received prior to the first food package being loaded to the storage rack.

3. The system of claim 1, wherein an order for the first food package is received prior to the first food package being loaded to the storage rack.

4. The system of claim 1, wherein the robotic arm includes one or more of a QR code reader, a RFID reader, a scanner, and an imaging device configured for interacting with an identifier on the first food package.

5. The system of claim 1, wherein the robotic arm is configured for travelling back and forth along a channel extending within the kiosk.

6. The system of claim 1, wherein the storage rack is rolled into the kiosk.

7. The system of claim 1, wherein the kiosk further comprises one or more of: a refrigeration device for cooling the first food package, and a microwave heating device for heating the first food package.

8. The system of claim 1, wherein the first food package includes an organic food item.

9. The system of claim 1, wherein the plurality of custom-prepared food packages is loaded onto the storage rack from an opening at or near a top surface of the kiosk.

10. The system of claim 1, wherein the plurality of custom-prepared food packages is loaded onto the storage rack by the robotic arm.

11. A server, comprising:
a processor communicably coupled to at least one memory; and program instructions which when executed by the processor cause the processor to:
receive, from a computing device, an order for a first food package to be custom prepared;
transmit, to a food preparation facility, the order for the first food package to be custom prepared;
track placement and position of a custom-prepared first food package in a storage rack within a vending kiosk, the kiosk configured for housing a plurality of custom-prepared food packages, each custom-prepared food package associated with a specific order received from a customer, the plurality of custom-prepared food packages positioned in the storage rack;
receive, on a user interface, a selection of the first food package by a user;
direct a controller in communication with a robotic arm located within the kiosk to cause the robotic arm to engage the first food package at the storage rack and deliver the first food package to a product delivery area of the kiosk; and
verify completion for the order.

12. The server of claim 11, wherein the server is configured to communicate with a vendor system to coordinate preparation of the custom-prepared first food package at a food processing facility and delivery of the prepared custom-prepared first food package to the vending kiosk.

13. The server of claim 11, wherein the server is configured to communicate with a mobile application operating on a mobile device associated with the customer.

14. The server of claim 11, wherein engaging the first food package at the storage rack includes reading an identifier on the first food package, and wherein directing the controller includes a lookup of a stocking location associated with the identifier of the first food package and communication of the stocking location to the robotic arm.

15. The server of claim 11, wherein the server is further configured to process a payment associated with the order.

16. The server of claim 11, wherein the controller is further configured to track stocking locations of each of the plurality of custom-prepared food packages.

17. The server of claim 11, wherein the server is further configured to include one or more of:
a data center supporting a network system for vending custom-prepared food packages to customers from a plurality of kiosks, each kiosk comprising a computing device and an interface for communicating with the data center over the network system, the data center comprising:
one or more data stores for storing inventory information corresponding to custom-prepared food packages in the plurality of kiosks,
one or more modules for receiving the inventory information from the plurality of kiosks and processing the inventory information to control inventory in the plurality of kiosks, and
a network interface for connecting to the network system,
wherein the data center is configured to connect to network interfaces of the plurality of kiosks over a network.

18. A method, comprising:
receiving, from a computing device, an order for a first food package to be custom prepared;
transmitting, to a food preparation facility, the order for the first food package to be custom prepared;
tracking placement and position of a custom-prepared first food package in a storage rack within a vending kiosk, the kiosk configured for housing a plurality of custom-prepared food packages, each custom-prepared food package associated with a specific order received from a customer, the plurality of custom-prepared food packages positioned in the storage rack;
receiving, on a user interface, a selection of the first food package by a user;
directing a controller coupled to a robotic arm located within the kiosk to engage the first food package at the storage rack and deliver the first food package to a product delivery area exterior of the kiosk; and
verifying completion for the order.

19. The method of claim 18, further comprising processing a payment associated with the order prior to the first food package being loaded to the storage rack.

20. The method of claim 18, further comprising:
reading an identifier on the first food package;
looking up a stocking location associated with the identifier of the first food package in the storage rack; and
communicating the stocking location to the robotic arm.
